(19) United States
(12) Patent Application Publication
(10) Pub. No.: US 2026/0267440 A1
(43) Pub. Date: Sep. 10, 2026

(54) DISPLAY DEVICE AND ELECTRONIC DEVICE

(71) Applicant: Samsung Display Co., Ltd., Yongin-Si (KR)

(72) Inventors: Il Ho LEE, Yongin-si (KR); Seung Rok LEE, Yongin-si (KR)

(21) Appl. No.: 19/326,729

(22) Filed: Sep. 12, 2025

(30) Foreign Application Priority Data
Mar. 4, 2025 (KR) 10-2025-0027421
Mar. 21, 2025 (KR) 10-2025-0036295

(51) Int. Cl. G06F 3/041; G06F 3/044

(52) U.S. Cl. CPC G06F 3/0418; G06F 3/04164; G06F 3/041662; G06F 3/0446

(57) ABSTRACT

A display device includes a display panel, a touch sensing unit, an electromagnetic wave attenuation unit, and a touch driving circuit. The electromagnetic wave attenuation unit includes a counter electrode. The touch driving circuit supplies a touch driving signal to at least one type of touch electrode among a plurality of first touch electrodes and a plurality of second touch electrodes. The touch driving circuit supplies a counter driving signal to the counter electrode and calculates a size of the counter driving signal based on an electromagnetic interference (EMI) emission factor detected from the touch sensing unit when the at least one type of touch electrode among the first touch electrodes and the second touch electrodes are driven by the touch driving signal.

### CROSS-REFERENCE TO RELATED APPLICATION

This application claims priority from Korean Patent Application Nos. 10-2025-0027421 filed on Mar. 4, 2025 and 10-2025-0036295 filed on Mar. 21, 2025 in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a display device, and more particularly, to a display device and an electronic device including the display device in which electromagnetic waves may be minimized.

### 2. Description of the Related Art

An organic light emitting display device includes a display element whose luminance is changed by current, for example, an organic light emitting diode.

### SUMMARY

Embodiments of the present disclosure provide a display device and an electronic device in which electromagnetic waves may be minimized.

An embodiment of a display device includes: a display panel; a touch sensing unit disposed on a display area of the display panel; an electromagnetic wave attenuation unit disposed on a non-display area of the display panel adjacent to the touch sensing unit; and a touch driving circuit connected to the touch sensing unit and the electromagnetic wave attenuation unit, wherein the touch sensing unit includes a plurality of first touch electrodes and a plurality of second touch electrodes disposed to intersect the plurality of first touch electrodes, the electromagnetic wave attenuation unit includes a counter electrode, the touch driving circuit supplies a touch driving signal to at least one type of touch electrode among the plurality of first touch electrodes and the plurality of second touch electrodes, the touch driving circuit supplies a counter driving signal to the counter electrode, and the touch driving circuit calculates a size of the counter driving signal based on an electromagnetic interference (EMI) emission factor detected from the touch sensing unit when the at least one type of touch electrode among the first touch electrodes and the second touch electrodes are driven by the touch driving signal.

An embodiment of an electronic device includes a display device having a display screen. The display device includes: a display panel; a touch sensing unit disposed on a display area of the display panel; an electromagnetic wave attenuation unit disposed on a non-display area of the display panel adjacent to the touch sensing unit; and a touch driving circuit connected to the touch sensing unit and the electromagnetic wave attenuation unit, the touch sensing unit includes a plurality of first touch electrodes and a plurality of second touch electrodes disposed to intersect the plurality of first touch electrodes, the electromagnetic wave attenuation unit includes a counter electrode, the touch driving circuit supplies a touch driving signal to at least one type of touch electrode among the plurality of first touch electrodes and the plurality of second touch electrodes, the touch driving circuit supplies a counter driving signal to the counter electrode, and the touch driving circuit calculates a size of the counter driving signal based on an electromagnetic interference (EMI) emission factor detected from the touch sensing unit when the at least one type of touch electrode among the first touch electrodes and the second touch electrodes are driven by the touch driving signal.

According to an embodiment, the electromagnetic waves of the display device and the electronic device may be minimized.

For example, the touch driving circuit may calculate the size of the counter driving signal based on an electromagnetic wave emission coefficient detected from the touch sensing unit, when the touch electrodes of the touch sensing unit are driven by the touch driving signal. Accordingly, the electromagnetic wave attenuation circuit that receives the counter driving signal may generate the counter electromagnetic wave capable of canceling the electromagnetic wave of the touch sensing unit. Therefore, the electromagnetic wave of the touch sensing unit may be minimized.

The effects of the present disclosure are not limited to the above-described effects and other effects which are not described herein will become apparent to those skilled in the art from the following description.

### BRIEF DESCRIPTION OF THE DRAWINGS

The above and other features of the present disclosure will become more apparent by describing embodiments thereof with reference to the attached drawings, in which:

FIG. 1 is a perspective view illustrating a display device according to an embodiment;

FIG. 2 is a plan view illustrating a display device according to an embodiment;

FIG. 3 is a cross-sectional view illustrating an example taken along line I-I′ of FIG. 2;

FIG. 4 is a plan view illustrating an example of a display panel of FIG. 3;

FIG. 5 is a plan view illustrating an example of a touch sensing unit of FIG. 3;

FIG. 6 is a view for describing an operation of a touch sensing unit and an electromagnetic wave attenuation unit according to an embodiment;

FIG. 7 is a timing diagram of a touch driving signal and a counter driving signal;

FIGS. 8 and 9 are diagrams for describing a method for detecting an electromagnetic interference (EMI) emission factor by a touch sensing unit driven in a self-capacitance method;

FIGS. 10 and 11 are diagrams for describing a method for detecting an electromagnetic interference (EMI) emission factor by a touch sensing unit driven in a mutual capacitance method;

FIG. 12 is a block diagram of an electronic device according to an embodiment; and

FIGS. 13, 14, and 15 are schematic diagrams of electronic devices according to various embodiments.

### DETAILED DESCRIPTION OF THE EMBODIMENTS

The present invention will now be described more fully hereinafter with reference to the accompanying drawings, in which embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

It will also be understood that when a layer is referred to as being “on” another layer or substrate, it can be directly on the other layer or substrate, or intervening layers may also be present. The same reference numbers indicate the same components throughout the specification. In the attached figures, the thickness of layers and regions is exaggerated for clarity.

Although the terms “first”, “second”, etc. may be used herein to describe various elements, these elements, should not be limited by these terms. These terms may be used to distinguish one element from another element. Thus, a first element discussed below may be termed a second element without departing from teachings of one or more embodiments. The description of an element as a “first” element may not require or imply the presence of a second element or other elements. The terms “first”, “second”, etc. may also be used herein to differentiate different categories or sets of elements. For conciseness, the terms “first”, “second”, etc. may represent “first-category (or first-set)”, “second-category (or second-set)”, etc., respectively.

Features of various embodiments of the present disclosure may be combined partially or totally. As will be clearly appreciated by those skilled in the art, technically various interactions and operations are possible. Various embodiments can be practiced individually or in combination.

Hereinafter, specific embodiments will be described with reference to the accompanying drawings.

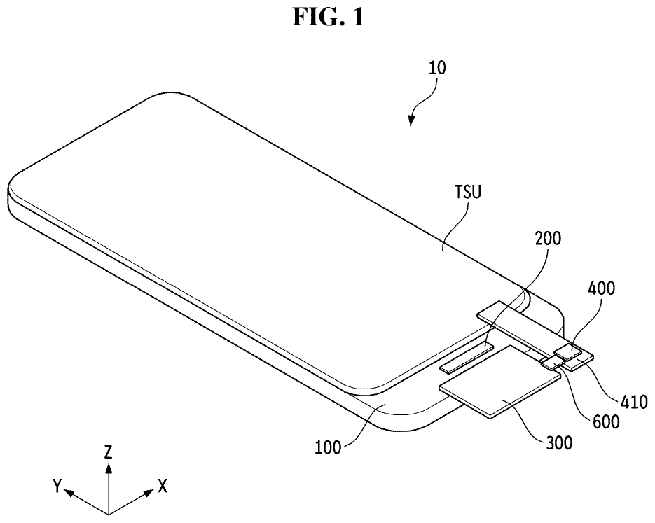

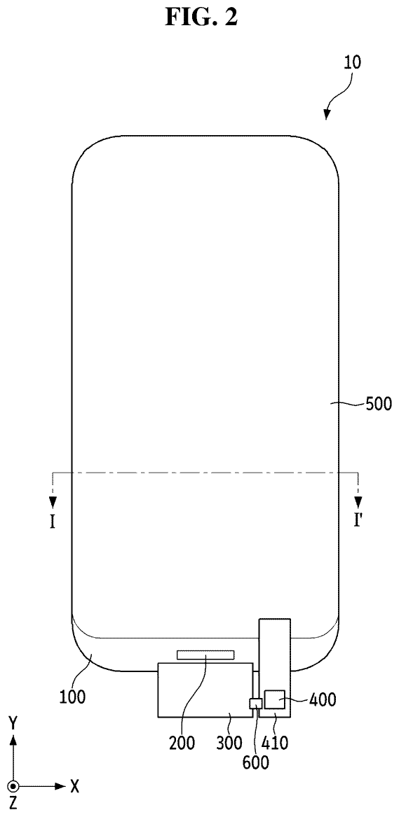

FIG. 1 is a perspective view illustrating a display device according to an embodiment. FIG. 2 is a plan view illustrating the display device according to an embodiment.

In the present specification, “upper portion”, “top”, and “upper surface” refer to a direction in which a touch sensing unit (TSU) is disposed based on a display panel 100, i.e., a Z-axis direction, and “lower portion”, “bottom”, and “lower” refer to a direction in which the display panel 100 is disposed based on the touch sensing unit (TSU), i.e., a direction opposite to the Z-axis direction. In addition, “left”, “right”, “upper”, and “lower” refer to directions when the display panel 100 is viewed in plan view. For example, “left” refers to a direction opposite to an X-axis direction, “right” refers to the X-axis direction, “upper” refers to a Y-axis direction, and “lower” refers to a direction opposite to the Y-axis direction.

Referring to FIGS. 1 and 2, a display device 10 is a device that displays a moving image or a still image, and may be used as a display screen of each of various products such as vehicle displays, televisions, laptop computers, monitors, billboards, and Internet of Things (IoT) as well as portable electronic devices such as mobile phones, smartphones, tablet personal computers (PCs), smartwatches, watch phones, mobile communication terminals, electronic organizers, electronic books, portable multimedia players (PMPs), navigation devices, and ultra mobile PCs (UMPCs). The display device 10 may be any one of an organic light emitting display device, a liquid crystal display device, a plasma display device, a field emission display device, an electrophoretic display device, an electrowetting display device, a quantum dot light emitting display device, and a micro LED display device. Hereinafter, it is mainly described that the display device 10 is an organic light emitting display device, but the present disclosure is not limited thereto.

The display device 10 according to an embodiment may include a display panel 100, a display driving circuit 200, a display circuit board 300, a touch driving circuit 400, a touch circuit board 410, and a touch sensing unit TSU.

The display panel 100 may be formed in a rectangular plane having short sides in a first direction (X-axis direction) and long sides in a second direction (Y-axis direction) intersecting the first direction (X-axis direction). A corner where the short side in the first direction (X-axis direction) and the long side in the second direction (Y-axis direction) meet may be rounded to have a curvature or may be formed at a right angle. The planar shape of the display panel 100 is not limited to the quadrangular shape, and may be formed in other polygonal, circular, or elliptical shapes.

The display panel 100 may be formed to be flat, but is not limited thereto, and may include curved portions formed at left and right ends. In this case, the curved portion may have a constant curvature or a changing curvature. In addition, the display panel 100 may be flexibly formed to be curved, bent, folded, or rolled.

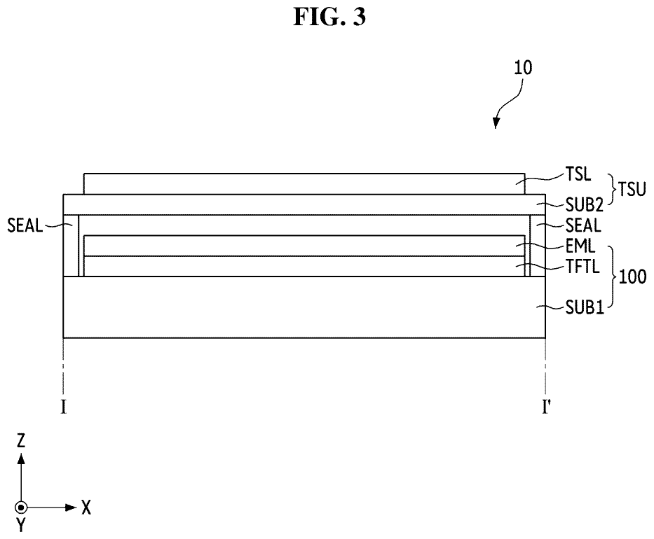

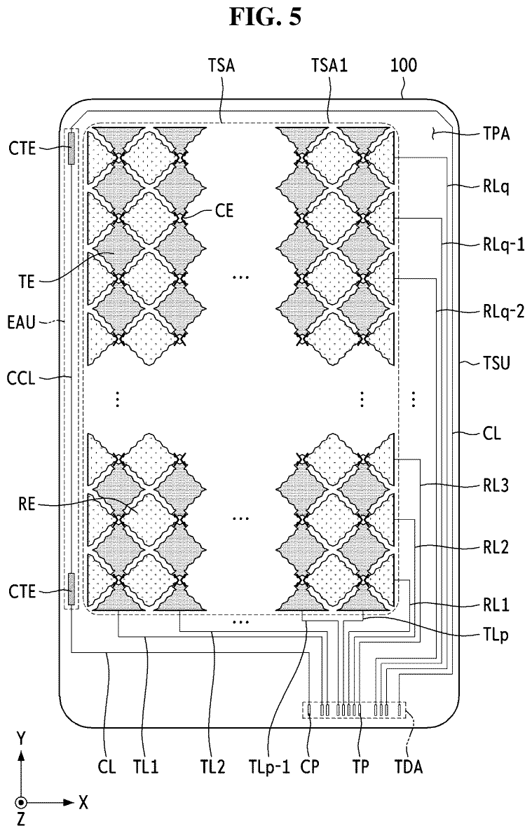

The display panel 100 may include pixels disposed in a display area to display an image and display electrode pads disposed in a non-display area around the display area. The display electrode pads may be disposed on the display panel 100 at one edge of the display panel 100 and electrically connected to the display circuit board 300. A detailed description of the display panel 100 will be described later with reference to FIGS. 3 and 5.

The display driving circuit 200 outputs signals and voltages for driving the display panel 100. For example, the display driving circuit 200 may supply data voltages to data lines. In addition, the display driving circuit 200 may supply a power voltage to a power line and scan control signals to a scan driver. The display driving circuit 200 may be formed as an integrated circuit (IC) and attached onto the display panel 100 by a chip on glass (COG) method, a chip on plastic (COP) method, or an ultrasonic bonding method. The display driving circuit 200 may be attached onto the exposed display panel 100 without being covered by the touch sensing unit TSU. Alternatively, the display driving circuit 200 may be mounted onto the display circuit board 300.

The display circuit board 300 may be attached onto the display electrode panels of the display panel 100 using an anisotropic conductive film. As a result, lead lines of the display circuit board 300 may be electrically connected to the display electrode pads of the display panel 100. The display circuit board 300 may be a flexible film such as a flexible printed circuit board, a printed circuit board, or a chip on film.

The touch sensing unit TSU may be disposed on the display panel 100. The touch sensing unit TSU may be formed in a rectangular plane having short sides in the first direction (X-axis direction) and long sides in the second direction (Y-axis direction). A corner where the short side in the first direction (X-axis direction) and the long side in the second direction (Y-axis direction) meet may be rounded to have a curvature or may be formed at a right angle. The planar shape of the touch sensing unit TSU is not limited to the quadrangular shape, and may be formed in other polygonal, circular, or elliptical shapes. The planar shape of the touch sensing unit TSU may be similar to the planar shape of the display panel 100.

The touch sensing unit TSU may be formed to be flat, but is not limited thereto, and may include curved portions formed at left and right ends. In this case, the curved portion may have a constant curvature or a changing curvature. In addition, the touch sensing unit TSU may be flexibly formed to be curved, bent, folded, or rolled.

The touch sensing unit TSU may include touch electrodes disposed in a touch sensor area to sense a user's touch and touch electrode pads TP (see FIG. 5) disposed in a touch peripheral area disposed around the touch sensor area. The touch electrode pads TP may be disposed on the touch sensing unit TSU at one edge of the touch sensing unit TSU and electrically connected to the touch circuit board 410. In addition, the touch circuit board 410 and the display circuit board 300 may be electrically connected to each other through a connection board 600.

A detailed description of the touch sensing unit TSU will be described later with reference to FIGS. 3 and 5. In addition, it is exemplified in FIGS. 1 and 2 that the touch sensing unit TSU is a separate touch panel distinct from the display panel 100, but the present disclosure is not limited thereto. For example, the touch sensing unit TSU may be directly disposed on a thin film encapsulation layer of the display panel 100.

The touch circuit board 410 may be attached onto the touch electrode pads of the touch sensing unit TSU using an anisotropic conductive film. As a result, lead lines of the touch circuit board 410 may be electrically connected to the touch electrode pads of the touch sensing unit TSU. The touch circuit board 410 may be a flexible film such as a flexible printed circuit board, a printed circuit board, or a chip on film.

The touch driving circuit 400 may be connected to the touch electrodes of the touch sensing unit TSU. The touch driving circuit 400 applies driving signals to the touch electrodes of the touch sensing unit TSU and measures capacitance values of the touch electrodes. The touch driving signal may be a signal having a plurality of driving pulses. The touch driving circuit 400 may not only determine whether a touch is input but also calculate touch coordinates where the touch is input, based on the capacitance values. The touch driving circuit 400 may be formed as an integrated circuit (IC) and disposed on the touch circuit board 410.

FIG. 3 is a cross-sectional view illustrating an example taken along line I-I′ of FIG. 2.

Referring to FIG. 3, the display device 10 may include a display panel 100, a touch sensing unit TSU, and an attachment member SEAL that attaches the display panel 100 and the touch sensing unit TSU.

The display panel 100 may include a first substrate SUB1, a thin film transistor layer TFTL, and a light emitting element layer EML.

The first substrate SUB1 may be a rigid substrate or a flexible substrate that may be bent, folded, or rolled. The first substrate SUB1 may include an insulating material such as glass, quartz, or a polymer resin. Examples of the polymer material may include polyethersulphone (PES), polyacrylate (PA), polyarylate (PAR), polyetherimide (PEI), polyethylene naphthalate (PEN), polyethylene terephthalate (PET), polyphenylene sulfide (PPS), polyallylate, polyimide (PI), polycarbonate (PC), cellulose triacetate (CAT), cellulose acetate propionate (CAP), or a combination thereof. Alternatively, the first substrate SUB1 may also include a metallic material.

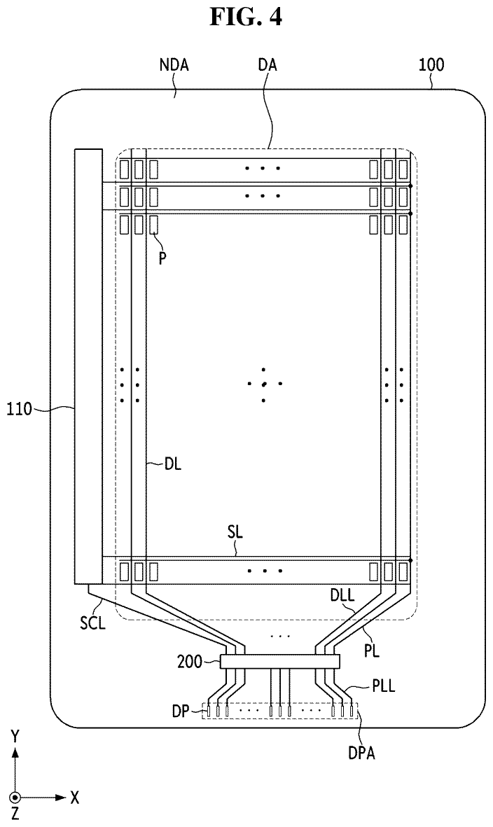

The thin film transistor layer TFTL may be disposed on the first substrate SUB1. In the thin film transistor layer TFTL, not only thin film transistors of each of the pixels, but also scan lines, data lines, power lines, scan control lines, data connection lines connecting the display driving circuit 200 and the data lines, and pad connection lines connecting the display driving circuit 200 and the display electrode pads may be disposed. Each of the thin film transistors may include a gate electrode, a semiconductor layer, a source electrode, and a drain electrode. When the scan driver 110 is disposed in the non-display area NDA of the display panel 100 as illustrated in FIG. 4, the scan driver 110 may include thin film transistors.

The thin film transistor layer TFTL may be disposed in the display area DA and the non-display area NDA. Specifically, the thin film transistors of each of the pixels, the scan lines, the data lines, and the power lines of the thin film transistor layer TFTL may be disposed in the display area DA. The scan control lines, the data connection lines, and the pad connection lines of the thin film transistor layer TFTL may be disposed in the non-display area NDA.

A light emitting element layer EML may be disposed on the thin film transistor layer TFTL. The light emitting element layer EML may include pixels in which a first electrode, a light emitting layer, and a second electrode are sequentially stacked to emit light, and a pixel defining film defining the pixels. The pixels of the light emitting element layer EML may be disposed in the display area DA.

The light emitting layer may be an organic light emitting layer including an organic material. In this case, the light emitting layer may include a hole transporting layer, an organic light emitting layer, and an electron transporting layer. When a predetermined voltage is applied to the first electrode and a cathode voltage is applied to the second electrode through the thin film transistor of the thin film transistor layer TFTL, holes and electrons move to the organic light emitting layer through the hole transporting layer and the electron transporting layer, respectively, and are bonded to each other in the organic light emitting layer to emit light. In this case, the first electrode may be an anode electrode and the second electrode may be a cathode electrode.

The touch sensing unit TSU may include a second substrate SUB2 and a touch sensor layer TSL.

The second substrate SUB2 may be a rigid substrate or a flexible substrate that may be bent, folded, or rolled. The second substrate SUB2 may include an insulating material such as glass, quartz, or a polymer resin. Examples of the polymer material may include polyethersulphone (PES), polyacrylate (PA), polyarylate (PAR), polyetherimide (PEI), polyethylene naphthalate (PEN), polyethylene terephthalate (PET), polyphenylene sulfide (PPS), polyallylate, polyimide (PI), polycarbonate (PC), cellulose triacetate (CAT), cellulose acetate propionate (CAP), or a combination thereof. Alternatively, the second substrate SUB2 may also include a metallic material. In addition, the second substrate SUB2 may serve as an encapsulation substrate that encapsulates the light emitting element layer EML.

The touch sensor layer TSL may be disposed on the second substrate SUB2. The touch sensor layer TSL may include touch electrodes for sensing a user's touch in a capacitance method, touch electrode pads, and touch signal lines connecting the touch electrode pads and the touch electrodes. For example, the touch sensor layer TSL may sense a user's touch in a self-capacitance method or a mutual capacitance method.

As illustrated in FIG. 5, the touch electrodes of the touch sensor layer TSL may be disposed in a touch sensor area TSA that overlaps the display area DA. The touch signal lines and the touch electrode pads TP of the touch sensor layer TSL may be disposed in a touch peripheral area TPA that overlaps the non-display area NDA. The touch peripheral area TPA may be disposed around the touch sensor area TSA.

A polarizing film and a cover window may be additionally disposed on the touch sensor layer TSL, and in this case, the polarizing film may be disposed on the touch sensor layer TSL, and the cover window may be attached onto the polarizing film by a transparent adhesive member.

The adhesive member SEAL may adhere the first substrate SUB1 of the display panel 100 and the second substrate SUB2 of the touch sensing unit TSU. The adhesive member SEAL may be, but is not limited to, a frit adhesive layer, an ultraviolet curable resin, or a heat curable resin.

It is exemplified in FIG. 3 that there is an empty space between the light emitting element layer EML and the second substrate SUB2, but the embodiment of the present disclosure is not limited thereto. For example, a filling film may be disposed between the light emitting element layer EML and the second substrate SUB2. The filling film may be an epoxy filled film or a silicone filled film.

FIG. 4 is a plan view illustrating an example of a display panel of FIG. 3. The display panel 100 includes pixels (P), scan lines SL, data lines DL, power lines PL, scan control lines SCL, a scan driver 110, a display driving circuit 200, display electrode pads DP, data connection lines DLL, and pad connection lines PLL of the display panel 100 are illustrated.

Referring to FIG. 4, the display panel 100 may include a display area DA in which pixels are disposed to display an image, and a non-display area NDA that is a peripheral area of the display area DA. The non-display area NDA may be defined as an area from the outside of the display area DA to an edge of the display panel 100.

The scan lines SL, the data lines DL, the power lines PL, and the pixels P may be disposed in the display area DA. The scan lines SL may be disposed parallel in a first direction (X-axis direction), and the data lines DL may be disposed parallel in a second direction (Y-axis direction) intersecting the first direction (X-axis direction). The power line PL may include at least one line disposed parallel to the data lines DL in the second direction (Y-axis direction) and a plurality of lines branching from at least one line in the first direction (X-axis direction).

Each of the pixels P may be connected to at least one of the scan lines SL, one of the data lines DL, and the power line PL. Each of the pixels P may include thin film transistors including a driving transistor and at least one switching transistor, thin film transistors, an organic light emitting diode, and a capacitor. Each pixel P may receive a data voltage of the data line DL when a scan signal is applied from the scan line SL, and may emit light by supplying the driving current to the organic light emitting diode according to the data voltage applied to the gate electrode.

The scan driver 110, the display driving circuit 200, the scan control line SCL, the data connection lines DLL, and pad connection lines PLL may be disposed in the non-display area NDA.

The scan driver 110 is connected to the display driving circuit 200 through at least one scan control line SCL. The scan driver 110 may receive the scan control signal from the display driving circuit 200. The scan driver 110 generates scan signals according to the scan control signal and supplies the scan signals to the scan lines SL.

It is illustrated in FIG. 4 that the scan driver 110 is disposed in the non-display area NDA outside one side of the display area DA, but the present disclosure is not limited thereto. For example, the scan driver 110 may be formed in the non-display area NDA outside both sides of the display area DA.

The display driving circuit 200 is connected to the display electrode pads DP of the display pad area DPA through the display connection lines PLL and receives digital video data and timing signals. The display driving circuit 200 converts the digital video data into analog positive/negative data voltages and supplies the analog positive/negative data voltages to the data lines DL through the data connection lines DLL. In addition, the display driving circuit 200 generates and supplies a scan control signal for controlling the scan driver 110 through the scan control line SCL. The pixels P to which the data voltages are to be supplied may be selected by the scan signals of the scan driver 110, and the data voltages may be supplied to the selected pixels P. The display driving circuit 200 may be formed as an integrated circuit (IC) and may be disposed on the first substrate SUB1 in a chip on glass (COG) manner, a chip on plastic (COP) manner, or an ultrasonic bonding manner.

FIG. 5 is a plan view illustrating an example of a touch sensing unit of FIG. 3.

Referring to FIG. 5, the touch sensing unit TSU includes a touch sensor area TSA for sensing a user's touch and a touch peripheral area TPA disposed around the touch sensor area TSA. The touch sensor area TSA may overlap the display area DA of the display panel 100, and the touch peripheral area TPA may overlap the non-display area NDA of the display panel 100.

The touch sensor area TSA may have a rectangular shape in plan view.

First touch electrodes TE and second touch electrodes RE may be disposed in the touch sensor area TSA. The first touch electrodes TE and the second touch electrodes RE may be spaced apart from each other. The first touch electrodes TE may be disposed in the second direction (Y-axis direction) in a plurality of columns, and the second touch electrodes RE may be disposed in the first direction (X-axis direction) in a plurality of rows. The first touch electrodes TE disposed in the second direction (Y-axis direction) in each of the plurality of columns may be electrically connected. In addition, the second touch electrodes RE disposed in the first direction (X-axis direction) in each of the plurality of rows may be electrically connected.

The first touch electrodes TE and the second touch electrodes RE may be disposed in a first touch sensor area TSA1, a second touch sensor area, and a third touch sensor area. The first touch electrodes TE and the second touch electrodes RE disposed in the first touch sensor area TSA1 may be formed in a diamond shape or a triangle shape in plan view. Specifically, the first touch electrodes TE and the second touch electrodes RE disposed at an edge of the first touch sensor area TSA1 may be formed in a triangular shape in plan view, and the remaining first touch electrodes TE and second touch electrodes RE may be formed in a diamond shape in plan view. In each of the second touch sensor area and the third touch sensor area, at least one first touch electrode TE and at least one second touch electrode RE may have an irregular shape. In addition, in order to prevent a moire phenomenon from occurring due to the first touch electrodes TE and the second touch electrodes RE when viewing an image of the display device 10, the first touch electrodes TE and the second touch electrodes RE may have convex and concave edges in plan view. The planar shape of the first touch electrodes TE and the second touch electrodes RE disposed in the first touch sensor area TSA1 is not limited to the shape illustrated in FIG. 5.

To prevent the first touch electrodes TE and the second touch electrodes RE from being short-circuited with each other at their intersection areas, the first touch electrodes TE adjacent to each other in the second direction (Y-axis direction) may be electrically connected through a connection electrode CE. In this case, the first touch electrodes TE and the second touch electrodes RE may be disposed in one layer, and the connection electrode CE may be disposed in a different layer from the first touch electrodes TE and the second touch electrodes RE. Due to this, the first touch electrodes TE electrically connected in the second direction (Y-axis direction) and the second touch electrodes RE electrically connected in the first direction (X-axis direction) may be electrically insulated from each other.

First touch signal lines TL1 to TLp (p is a positive integer greater than or equal to 2), second touch signal lines RL1 to RLq (q is a positive integer greater than or equal to 2), and the electrode pads TP may be disposed in a touch peripheral area TPA.

One end of the first touch signal lines TL1 to TLp may be connected to the first touch electrodes TE disposed on a first side of the touch sensor area TSA. The first side of the touch sensor area TSA may be a side closest to the touch pad area TDA on which the touch electrode pads TP are disposed among the four sides of the touch sensor area TSA. A second side of the touch sensor area TSA may be a side facing the first side, and third and fourth sides of the touch sensor area TSA may be sides disposed between the first and second sides. In this case, the third side may be, for example, a side on which the second touch signal lines RL1 to RLq described above are disposed, and the fourth side may be a side facing the third side. The other ends of the first touch signal lines TL1 to TLp may be connected to some touch electrode pads TP of the touch pad area TDA. That is, the first touch signal line TL1 to TLp serves to connect the first touch electrodes TE disposed on the first side of the touch sensor area TSA and some touch electrode pads TP of the touch pad area TDA.

For example, as illustrated in FIG. 5, a first_first touch signal line TL1 may be electrically connected to the first touch electrodes TE disposed in a first column of the touch sensor area TSA, and a first_second touch signal line TL2 may be electrically connected to the first touch electrodes TE disposed in a second column of the touch sensor area TSA. In addition, a first_p touch signal line TLp-1 may be electrically connected to the first touch electrodes TE disposed in a p-1-th column of the touch sensor area TSA, and a first_p touch signal line TLp may be electrically connected to the first touch electrodes TE disposed in a p-th column of the touch sensor area TSA. In this case, the first column of the touch sensor area TSA may be a column disposed at the leftmost side of the touch sensor area TSA, and the p-th column of the touch sensor area TSA may be a column disposed at the rightmost side of the touch sensor area TSA.

One end of the second touch signal lines RL1 to RLq may be connected to the second touch electrodes RE disposed on a third side of the touch sensor area TSA. The other ends of the second touch signal lines RL1 to RLq may be connected to the remaining touch electrode pads TP of the touch pad area TDA. That is, the second touch signal line RL1 to RLq serves to connect the second touch electrodes RE disposed on the third side of the touch sensor area TSA and the remaining touch electrode pads TP of the touch pad area TDA.

For example, as illustrated in FIG. 5, a second_first touch signal line RL1 may be electrically connected to the second touch electrodes RE disposed in a first row of the touch sensor area TSA, a second_second touch signal line RL2 may be electrically connected to the second touch electrodes RE disposed in a second row of the touch sensor area TSA, and a second_third touch signal line RL3 may be electrically connected to the second touch electrodes RE disposed in a third row of the touch sensor area TSA. In addition, a second_q touch signal line RLq-2 may be electrically connected to the second touch electrodes RE disposed in a q-2-th row of the touch sensor area TSA, a second_(q-1) touch signal line RLq-1 may be electrically connected to the second touch electrodes RE disposed in a q-1-th row of the touch sensor area TSA, and a second_q touch signal line RLq may be electrically connected to the second touch electrodes RE disposed in a q-th row of the touch sensor area TSA.

The touch electrode pads TP may be disposed on one side of the second substrate SUB2. The touch circuit board 410 may be attached onto the touch electrode pads TP using an anisotropic conductive film. Due to this, the touch electrode pads TP may be electrically connected to the touch circuit board 410.

The first touch electrodes TE and the second touch electrodes RE may be driven by at least one of a mutual capacitance method and a self-capacitance method.

For example, when the first touch electrodes TE and the second touch electrodes RE are driven by the self-capacitance method, the touch driving circuit 400 simultaneously supplies the touch driving signals to all of the first touch electrodes TE through the first touch signal lines TL1 to TLp, and then simultaneously supplies the touch driving signals to all of the second touch electrodes RE through the second touch signal lines RL1 to RLq, thereby charging self-capacitances of the first touch electrodes TE and the second touch electrodes RE. Then, charge change amounts of the self-capacitances are measured through the first touch signal lines TL1 to TLp and the second touch signal lines RL1 to RLq, and whether a touch input has occurred is determined based on the charge change amounts of the self-capacitances.

When the first touch electrodes TE and the second touch electrodes RE are driven in the mutual capacitance method, the touch driving circuit 400 supplies the touch driving signals to the first touch electrodes TE through the first touch signal lines TL1 to TLp to charge mutual capacitances formed at the intersection areas of the first touch electrodes TE and the second touch electrodes RE. Then, charge changes of the mutual capacitances are measured through the second touch electrodes RE, and whether a touch input has occurred is determined based on the charge changes of the mutual capacitances. The touch driving signal may be a signal having a plurality of touch driving pulses.

In addition, as illustrated in FIG. 5, an electromagnetic wave attenuation unit EAU may be disposed on the display panel 100. For example, the electromagnetic wave attenuation unit EAU may be disposed on the second substrate SUB2 so as to overlap the display panel 100. For example, the electromagnetic wave attenuation unit EAU may be disposed at the edge of the second substrate SUB2 so as to overlap the non-display area NDA of the display panel 100. In this case, the electromagnetic wave attenuation unit EAU may be disposed adjacent to the touch sensor area TSA.

The electromagnetic wave attenuation unit EAU may include at least one counter electrode CTE. For example, as illustrated in FIG. 5, the electromagnetic wave attenuation unit EAU may include two counter electrodes CTE. The two counter electrodes CTE may be disposed to face each other in the second direction. In this case, the two counter electrodes CTE may be disposed at one edge of the non-display area NDA and at the other edge of the non-display area NDA. The two counter electrodes CTE may be disposed along one direction (e.g., the second direction (Y-axis direction)) in the non-display area NDA. The number of counter electrodes CTE may be one or three or more. The counter electrodes CTE adjacent to each other may be connected to each other through a counter connection line CCL.

The counter electrode CTE may include, for example, the same material as either the first touch electrode TE or the second touch electrode RE.

The electromagnetic wave attenuation unit EAU may be connected to a counter pad CP through a counter signal line CL. The counter pad CP may be connected to the counter signal line CL and the touch circuit board 410. The electromagnetic wave attenuation unit EAU may be electrically connected to the touch driving circuit 400 through the counter signal line CL, the counter pad CP, and the touch circuit board 410. In other words, the counter electrodes CTE of the electromagnetic wave attenuation unit EAU may be electrically connected to the touch driving circuit 400 through the counter signal line CL, the counter pad CP, and the touch circuit board 410.

The counter pads CP may be disposed on one side of the second substrate SUB2. The touch circuit board 410 may be attached onto the counter pads CP using an anisotropic conductive film. Due to this, the counter pads CP may be electrically connected to the touch circuit board 410.

The touch driving circuit 400 may generate a counter driving signal. The counter driving signal from the touch driving circuit 400 may be supplied to the electromagnetic wave attenuation unit EAU through the counter pad CP and the counter signal line CL. For example, the counter driving signal from the touch driving circuit 400 may be supplied to the counter electrode CTE of the electromagnetic wave attenuation unit EAU. Electromagnetic waves generated from the touch sensing unit TSU may be canceled by counter electromagnetic waves from the electromagnetic wave attenuation unit EAU. Accordingly, the size of electromagnetic waves generated from the touch sensing unit TSU when the touch sensing unit TSU is driven may be minimized.

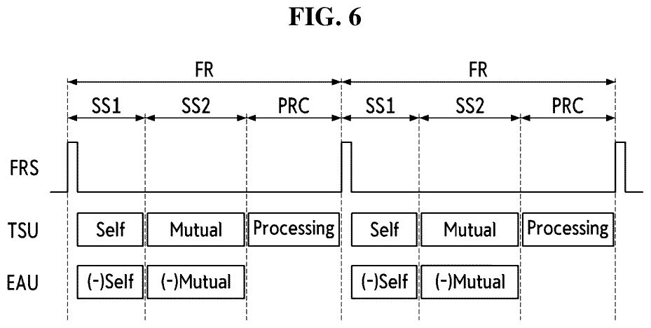

FIG. 6 is a view for describing an operation of a touch sensing unit TSU and an electromagnetic wave attenuation unit EAU according to an embodiment.

As illustrated in FIG. 6, a frame signal FRS may define a frame period.

One frame period FR may include a first sensing period SS1, a second sensing period SS2, and a processing period PRC.

During the first sensing period SS1, the touch sensing unit TSU may be driven in a self-capacitance method.

During the second sensing period SS2, the touch sensing unit TSU may be driven in a mutual capacitance method.

During the processing period PRC, whether a touch input has occurred may be determined based on a charge change amount of a self-capacitance and a charge change amount of a mutual capacitance detected by the touch sensing unit TSU during the first sensing period SS1 and the second sensing period SS2 described above. The determination of whether or not such touch input has occurred may be performed by the touch driving circuit 400 described above.

During the first sensing period SS1, the electromagnetic wave attenuation unit EAU may generate a counter electromagnetic wave for canceling out an electromagnetic wave generated from the touch sensing unit TSU (e.g., the touch sensing unit TSU driven by the self-capacitance method).

During the second sensing period SS2, the electromagnetic wave attenuation unit EAU may generate a counter electromagnetic wave for canceling out an electromagnetic wave generated from the touch sensing unit TSU (e.g., the touch sensing unit TSU driven by the mutual capacitance method).

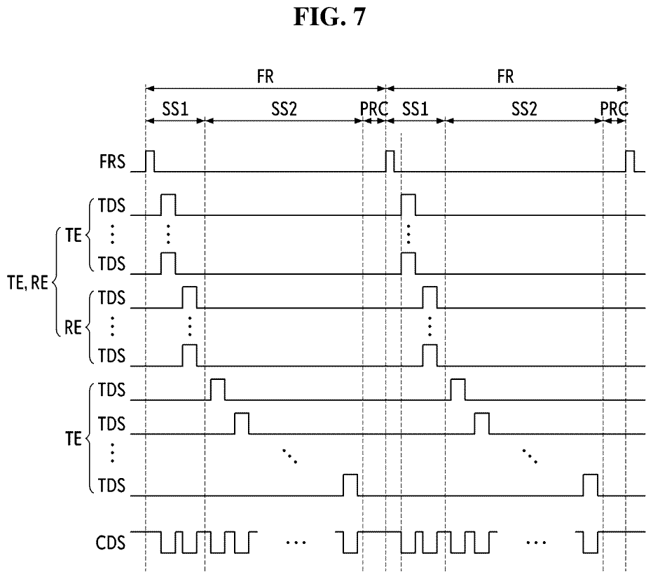

FIG. 7 is a timing diagram of a touch driving signal TDS and a counter driving signal CDS.

During the first sensing period SS1, the touch driving circuit 400 may simultaneously supply touch driving signals TDS to the first touch electrodes TE of the touch sensing unit TSU through the first touch signal lines TL1 to TLp. Next, during the first sensing period SS1, the touch driving circuit 400 may simultaneously supply the touch driving signals TDS to the second touch electrodes RE of the touch sensing unit TSU through the second touch signal lines RL1 to RLq.

During the second sensing period SS2, the touch driving circuit 400 may sequentially supply the touch driving signals TDS to the first touch electrodes TE of the touch sensing unit TSU through the first touch signal lines TL1 to TLp.

During the first sensing period SS1, the touch driving circuit 400 may supply a counter driving signal CDS to the counter electrode CTE of the electromagnetic wave attenuation unit EAU through the counter signal line CL. In this case, an output timing of the counter driving signal CDS output in the first sensing period SS1 may be the same as an output timing of the touch driving signals TDS output in the first sensing period SS1 described above.

During the second sensing period SS2, the touch driving circuit 400 may sequentially supply a plurality of counter driving signals CDS to the counter electrode CTE of the electromagnetic wave attenuation unit EAU through the counter signal line CL. In this case, each output timing of the counter driving signals CDS output in the second sensing period SS2 may be the same as each output timing of the touch driving signals TDS output in the second sensing period SS2 described above.

In this way, a generation timing of the counter driving signal CDS and a generation timing of the touch driving signal TDS may be synchronized with each other. For example, the counter driving signal CDS may be generated at the generation timing of the touch driving signal TDS. The touch driving signal TDS and the counter driving signal CDS may be simultaneously output. In other words, whenever the touch driving signal TDS is output, the counter driving signal CDS may be output in synchronization with the output timing of the touch driving signal TDS.

The counter driving signal CDS may be a signal having a plurality of driving pulses. In this case, the counter driving signal CDS may be a signal that is inverted by 180 degrees with respect to the touch driving signal TDS. In addition, a polarity of the counter driving signal CDS may be different from a polarity of the touch driving signal TDS. For example, when the touch driving signal TDS is a positive signal, the counter driving signal CDS may be a negative signal.

When the touch driving signals TDS are applied to the touch sensing unit TSU, electromagnetic waves may be generated from the touch sensing unit TSU due to an influence of the touch driving signals TDS. In addition, when the counter driving signals CDS are applied to the electromagnetic wave attenuation unit EAU, electromagnetic waves (e.g., counter electromagnetic waves) may be generated from the electromagnetic wave attenuation unit EAU due to an influence of the counter driving signals CDS. In this case, the electromagnetic waves generated from the touch sensing unit TSU may be canceled by the counter electromagnetic waves from the electromagnetic wave attenuation unit EAU. Accordingly, the size of electromagnetic waves generated from the touch sensing unit TSU when the touch sensing unit TSU is driven may be minimized.

The touch driving circuit 400 may generate a counter driving signal CDS based on an electromagnetic interference (EMI) emission factor of the touch sensing unit TSU. Here, the EMI emission factor of the touch sensing unit TSU may be determined by an actual capacitance of the touch sensing unit TSU, a design capacitance of the touch sensing unit TSU, and the magnitude (e.g., pulse magnitude) of the touch driving signal TDS applied to the touch sensing unit TSU.

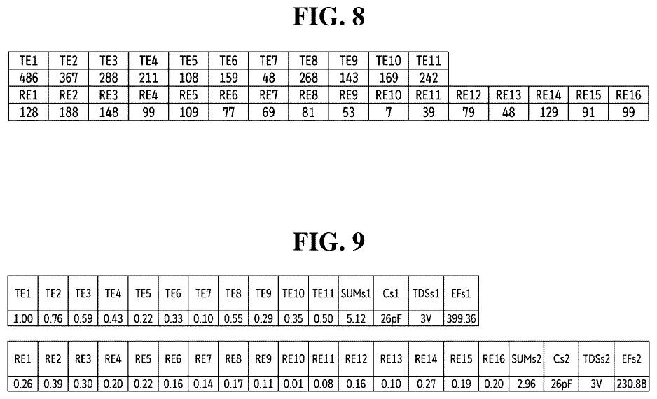

FIGS. 8 and 9 are diagrams for describing a method for detecting an electromagnetic interference (EMI) emission factor by which a touch sensing unit is driven in a self-capacitance method.

First, for convenience of explanation, it is assumed that the plurality of first touch signal lines include 11 first touch signal lines, and the plurality of second touch signal lines include 16 second touch signal lines. For example, the plurality of first touch signal lines may include a first_first touch signal line, a first_second touch signal line, a first_third touch signal line, a first_fourth touch signal line, a first_fifth touch signal line, a first_sixth touch signal line, a first_seventh touch signal line, a first_eighth touch signal line, a first_ninth touch signal line, a first_tenth touch signal line, and a first_eleventh touch signal line. In addition, the plurality of second touch signal lines may include a second_first touch signal line, a second_second touch signal line, a second_third touch signal line, a second_fourth touch signal line, a second_fifth touch signal line, a second_sixth touch signal line, a second_seventh touch signal line, a second_eighth touch signal line, a second_ninth touch signal line, a second_tenth touch signal line, a second_eleventh touch signal line, a second_twelfth touch signal line, a second_thirteenth touch signal line, a second_fourteenth touch signal line, a second_fifteenth touch signal line, and a second_sixteenth touch signal line.

11 first touch electrodes may be respectively connected to the 11 first touch signal lines described above. For example, the plurality of first touch electrodes TE may include a first_first touch electrode TE1 connected to the first_first touch signal line, a first_second touch electrode TE2 connected to the first_second touch signal line, a first_third touch electrode TE3 connected to the first_third touch signal line, a first_fourth touch electrode TE4 connected to the first_fourth touch signal line, a first_fifth touch electrode TE5 connected to the first_fifth touch signal line, a first_sixth touch electrode TE6 connected to the first_sixth touch signal line, a first_seventh touch electrode TE7 connected to the first_seventh touch signal line, a first_eighth touch electrode TE8 connected to the first_eighth touch signal line, a first_ninth touch electrode TE9 connected to the first_ninth touch signal line, a first_tenth touch electrode TE10 connected to the first_tenth touch signal line, and a first_eleventh touch electrode TE11 connected to the first_eleventh touch signal line.

16 second touch electrodes may be respectively connected to the 16 second touch signal lines described above. For example, the plurality of second touch electrodes RE may include a second_first touch electrode RE1 connected to the second_first touch signal line, a second_second touch electrode RE2 connected to the second_second touch signal line, a second_third touch electrode RE3 connected to the second_third touch signal line, a second_fourth touch electrode RE4 connected to the second_fourth touch signal line, a second_fifth touch electrode RE5 connected to the second_fifth touch signal line, a second_sixth touch electrode RE6 connected to the second_sixth touch signal line, a second_seventh touch electrode RE7 connected to the second_seventh touch signal line, a second_eighth touch electrode RE8 connected to the second_eighth touch signal line, a second_ninth touch electrode RE9 connected to the second_ninth touch signal line, a second_tenth touch electrode RE10 connected to the second_tenth touch signal line, a second_eleventh touch electrode RE11 connected to the second_eleventh touch signal line, a second_twelfth touch electrode RE12 connected to the second_twelfth touch signal line, a second_thirteenth touch electrode RE13 connected to the second_thirteenth touch signal line, a second_fourteenth touch electrode RE14 connected to the second_fourteenth touch signal line, a second_fifteenth touch electrode RE15 connected to the second_fifteenth touch signal line, and a second_sixteenth touch electrode RE16 connected to the second_sixteenth touch signal line.

To enable the touch sensing unit TSU to be driven in the self-capacitance method, the touch driving circuit 400 may simultaneously supply the touch driving signals TDS to the first_first to first_eleventh touch electrodes TE1 to TE11 of the touch sensing unit TSU, and then simultaneously supply the touch driving signals TDS to the second_first to second_sixteenth touch electrodes RE1 to RE16. Then, the self-capacitance (e.g., the charge change amount of the self-capacitances) of each of the touch electrodes TE1 to TE11 and RE1 to RE16 may be detected. For example, the self-capacitance in an overlapping area between each of the touch electrodes TE1 to TE11 and RE1 to RE16 and the display panel 100 (e.g., the light emitting element layer of the display panel 100 (e.g., the cathode electrode of the light emitting element layer)) may be detected. The touch driving circuit 400 may convert the detected self-capacitance into a digital value through an analog-to-digital converter. FIG. 8 illustrates digital values for the self-capacitance of each of the touch electrodes TE1 to TE11 and RE1 to RE16.

For example, as illustrated in FIG. 8, the self-capacitance of the first_first touch electrode TE1 may have a digital value of 486, the self-capacitance of the first_second touch electrode TE2 may have a digital value of 367, and the self-capacitance of the first_third touch electrode TE3 may have a digital value of 288, and the self-capacitance of the second_first touch electrode RE1 may have a digital value of 128, the self-capacitance of the second_second touch electrode RE2 may have a digital value of 188, and the self-capacitance of the second_third touch electrode RE3 may have a digital value of 148.

Thereafter, the touch driving circuit 400 may normalize the self-capacitances described above. For example, the touch driving circuit 400 may normalize the self-capacitances based on a maximum value among the self-capacitances. In other words, the touch driving circuit 400 may divide each of the self-capacitances by a maximum self-capacitance (e.g., a self-capacitance (i.e., 486) having the largest value among the 27 self-capacitances of FIG. 8). FIG. 9 illustrates a normalized self-capacitance (hereinafter, normalization self-capacitance) of each touch electrode.

For example, as illustrated in FIG. 9, the normalization self-capacitance of the first_first touch electrode TE1 may be 1, the normalization self-capacitance of the first_second touch electrode TE2 may be 0.76, and the normalization self-capacitance of the first_third touch electrode TE3 may be 0.59, and the normalization self-capacitance of the second_first touch electrode RE1 may be 0.26, the normalization self-capacitance of the second_second touch electrode RE2 may be 0.39, and the normalization self-capacitance of the second_third touch electrode RE3 may be 0.30.

Next, the touch driving circuit 400 may calculate the EMI emission factor of the touch sensing unit TSU when the first touch electrodes TE of the touch sensing unit TSU are driven in the self-capacitance method based on the following mathematical formula 1.

$$EFs 1 = SUMs 1 * Cs 1 * TDSs 1 \qquad 〈 Mathematical Formula 1 〉$$

In the mathematical formula 1, EFs1 is the EMI emission factor of the touch sensing unit TSU when the first touch electrodes TE of the touch sensing unit TSU are driven in the self-capacitance method, SUMs1 is the sum of normalization self-capacitances of all the first touch electrodes (e.g., the first_first to first_eleventh touch electrodes), Cs1 is an actual capacitance of all the first touch electrodes (e.g., the first_first to first_eleventh touch electrodes TE1 to TE11), and TDSs1 is a size of the touch driving signal TDS applied to the first touch electrodes TE during the first sensing period SS1.

For example, as illustrated in FIG. 9, when SUMs1 is 5.12, Cs1 is 26 pF, and TDSs1 is 3 V, the EMI emission factor of the touch sensing unit TSU according to the touch driving signals TDS applied to the first touch electrodes TE1 to TE11 may be 399.36.

Thereafter, the touch driving circuit 400 may calculate the EMI emission factor of the touch sensing unit TSU when the second touch electrodes RE1 to RE16 of the touch sensing unit TSU are driven in the self-capacitance method based on the following mathematical formula 2.

$$EFs 2 = SUMs 2 * Cs 2 * TDSs 2 \qquad 〈 Mathematical Formula 2 〉$$

In the mathematical formula 2, EFs2 is the EMI emission factor of the touch sensing unit TSU when the second touch electrodes RE1 to RE16 of the touch sensing unit TSU are driven in the self-capacitance method, SUMs2 is the sum of normalization self-capacitances of all the second touch electrodes (e.g., second_first to second_sixteenth touch electrodes RE1 to RE16), Cs2 is an actual capacitance of all the second touch electrodes (e.g., second_first to second_sixteenth touch electrodes RE1 to RE16), and TDSs2 is a size of the touch driving signal TDS applied to the second touch electrodes RE during the first sensing period SS1.

For example, as illustrated in FIG. 9, when SUMs2 is 2.96, Cs2 is 26 pF, and TDSs2 is 3 V, the EMI emission factor of the touch sensing unit TSU according to the touch driving signals TDS applied to the second touch electrodes RE1 to RE16 may be 399.47.

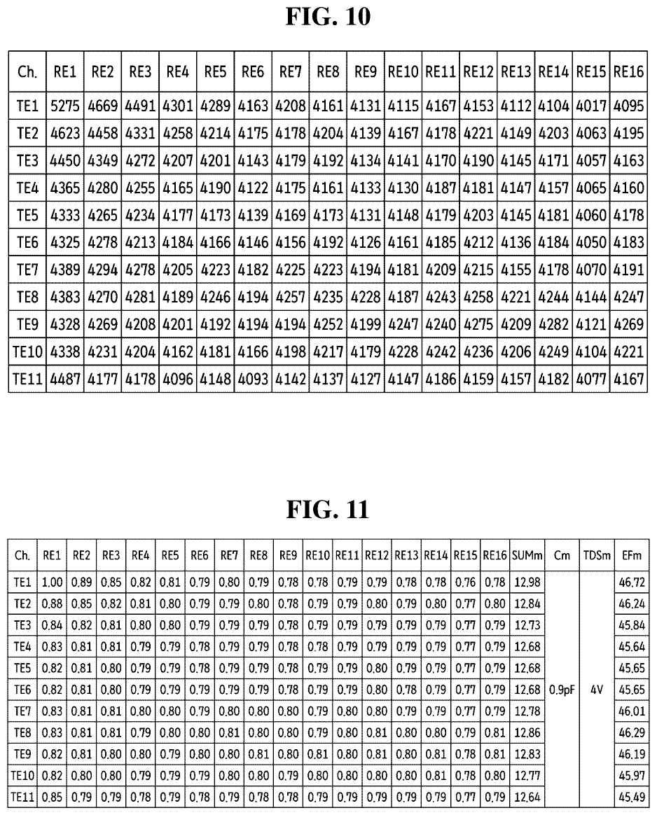

FIGS. 10 and 11 are diagrams for describing a method for detecting an electromagnetic interference (EMI) emission factor by which a touch sensing unit TSU is driven in a mutual capacitance method.

The touch driving circuit 400 may sequentially supply the touch driving signals TDS to the first_first to the first_eleventh touch electrodes TE1 to TE16 of the touch sensing unit TSU so that the touch sensing unit TSU is driven in the mutual capacitance method. Then, a mutual capacitance (e.g., a charge change amount of the mutual capacitances) of each of the touch electrodes TE1 to TE11 and RE1 to RE16 may be detected. For example, a mutual capacitance in an overlapping area between the first touch electrode TE and the second touch electrode RE that intersect each other may be detected. The touch driving circuit 400 may convert the detected mutual capacitance into a digital value through an analog-to-digital converter. FIG. 10 illustrates a digital value for the mutual capacitance of each touch electrode.

For example, as illustrated in FIG. 10, the mutual capacitance between the first_first touch electrode TE1 and the second_first touch electrode RE1 that intersect each other may have a digital value of 5275, the mutual capacitance between the first_second touch electrode TE2 and the second_second touch electrode RE2 that intersect each other may have a digital value of 4458, and the mutual capacitance between the first_third touch electrode TE3 and the second_third touch electrode RE3 that intersect each other may have a digital value of 4272.

Thereafter, the touch driving circuit 400 may normalize the mutual capacitances described above for each first touch electrode TE. For example, the touch driving circuit 400 may normalize the mutual capacitances for each first touch electrode TE based on a maximum value among the mutual capacitances. In other words, the touch driving circuit 400 may divide each of the 16 mutual capacitances (e.g., 5275, 4669, 4491, 4301, 4289, 4163, 4208, 4161, 4131, 4115, 4167, 4153, 4112, 4104, 4017, and 4095) between the first_first touch electrode TE1 and the second_first to second_sixteenth touch electrodes RE1 to RE16 by a maximum mutual capacitance (e.g., a mutual capacitance (i.e., 5275) having the largest value among the 176 capacitances of FIG. 10). FIG. 10 illustrates a normalized mutual capacitance (hereinafter, normalization mutual capacitance) normalized for each first touch electrode TE.

For example, as illustrated in FIG. 10, the normalization mutual capacitances of the first_first touch electrode TE1 overlapping the second_first to second_sixteenth touch electrodes RE1 to RE16 may be 1.00, 0.89, 0.85, 0.82, 0.81, 0.79, 0.80, 0.79, 0.78, 0.78, 0.79, 0.79, 0.78, 0.78, 0.76 and 0.78, respectively, and the normalization mutual capacitances of the first_second touch electrode TE2 overlapping the second_first to second_sixteenth touch electrodes RE1 to RE16 may be 0.88, 0.85, 0.82, 0.81, 0.80, 0.79, 0.79, 0.80, 0.78, 0.79, 0.79, 0.80, 0.79, 0.80, 0.77 and 0.80, respectively.

Next, the touch driving circuit 400 may calculate the EMI emission factor of the touch sensing unit TSU when the first touch electrodes TE1 to TE11 of the touch sensing unit TSU are driven in the mutual capacitance method based on the following mathematical formula 3.

$$EFm = SUMm * Cm * TDSm \qquad 〈 Mathematical Formula 3 〉$$

In the mathematical formula 3, EFm is the EMI emission factor of the touch sensing unit TSU when the first touch electrodes TE1 to TE11 of the touch sensing unit TSU are driven in the mutual capacitance method, SUMm is the sum of all normalization mutual capacitances (e.g., 1.00, 0.89, 0.85, 0.82, 0.81, 0.79, 0.80, 0.79, 0.78, 0.78, 0.79, 0.79, 0.78, 0.78, 0.76, and 0.78) of one first touch electrode (e.g., the first_first touch electrode TE1), Cm is an actual capacitance between all the first touch electrodes TE1 to TE11 and all the second touch electrodes RE1 to RE16, and TDSm is to a size of the touch driving signal TDS applied to the first touch electrodes TE1 to TE11 during the second sensing period SS2.

For example, as illustrated in FIG. 11, when SUMm which is the sum of the normalization mutual capacitances of the first_first touch electrode TE1 is 12.98, Cm is 0.9 pF, and TDSm is 4 V, the EMI emission factor of the touch sensing unit TSU according to the touch driving signal TDS applied to the first_first touch electrode TE1 may be 46.72.

In addition, as illustrated in FIG. 11, when SUMm which is the sum of the normalization mutual capacitances of the first_second touch electrode TE2 is 12.84, Cm is 0.9 pF, and TDSm is 4 V, the EMI emission factor of the touch sensing unit TSU according to the touch driving signal TDS applied to the first_second touch electrode TE2 may be 46.24.

Next, the touch driving circuit 400 may supply the counter driving signal CDS to the counter electrode CTE of the electromagnetic wave attenuation unit EAU. Then, a capacitance (e.g., a charge change amount of the self-capacitance) of the counter electrode CTE may be detected. For example, the self-capacitance in an overlapping area between the counter electrode CTE and the display panel 100 (e.g., the light emitting element layer of the display panel 100 (e.g., the cathode electrode of the light emitting element layer)) may be detected. The touch driving circuit 400 may convert the detected self-capacitance into a digital value through an analog-to-digital converter.

In this way, the EMI emission factor of the touch sensing unit TSU when the first touch electrodes TE1 to TE11 are simultaneously driven in the self-capacitance method, the EMI emission factor of the touch sensing unit TSU when the second touch electrodes RE1 to RE16 are simultaneously driven in the self-capacitance method, and the EMI emission factor of the touch sensing unit TSU when the first touch electrodes TE1 to TE11 are sequentially driven in the mutual capacitance method may be respectively calculated. In addition, the capacitance (e.g., the self-capacitance) of the counter electrode CTE may be detected.

Thereafter, the touch driving circuit 400 may compensate for the size of the counter driving signal CDS so that the EMI emission factor of the electromagnetic wave attenuation unit EAU and the EMI emission factor of the touch sensing unit TSU become equal to each other.

Here, the touch driving circuit 400 may calculate the EMI emission factor of the electromagnetic wave attenuation unit EAU based on the following mathematical formula 4.

$$EFe = SFe * Ce * CSe \qquad 〈 Mathematical Formula 4 〉$$

In the mathematical formula 4, EFe is the EMI emission factor of the electromagnetic wave attenuation unit EAU, SFe is the normalization self-capacitance of the counter electrode CTE, Ce is an actual capacitance of the counter electrode CTE, and CSe is a size of the counter driving signal CDS.

Here, the normalization self-capacitance of the counter electrode CTE may be calculated by the following method.

For example, the touch driving circuit 400 may normalize the self-capacitances of the counter electrode CTE. In other words, the touch driving circuit 400 may normalize the self-capacitances of the counter electrode CTE based on the self-capacitance (e.g., 486 in FIG. 8) having the largest value among the self-capacitances of the first touch electrodes TE1 to TE11 calculated when the first touch electrodes TE1 to TE11 described above are driven in the self-capacitance method. As an example, when the self-capacitance of the counter electrode CTE is 800, a normalization self-capacitance of the counter electrode CTE may be 1.65.

Ce in the above-described mathematical formula 4 may be identical to Cs1 in the above-described mathematical formula 1. For example, Ce may mean the actual capacitance of all the first touch electrodes TE1 to TE11.

Here, in order to cancel out electromagnetic waves generated from the touch sensing unit TSU when the first touch electrodes TE1 to TE11 of the touch sensing unit TSU are driven in the self-capacitance method, the touch driving circuit 400 may compensate for the counter driving signal CDS. For example, the touch driving circuit 400 may calculate the value of the counter driving signal CDS that makes the EMI emission factor (e.g., EFs1) of the above-described mathematical formula 1 and the EMI emission factor (e.g., Efe) of the above-described mathematical formula 4 equal to each other.

As a specific example, when the actual capacitance (e.g., Cs1) of all the first touch electrodes TE1 to TE11 is 26 pF (see FIG. 9), the maximum self-capacitance having the largest value among the self-capacitances of the first touch electrodes TE1 to TE11 is 486 (see FIG. 8), the EMI emission factor of the touch sensing unit TSU when the first touch electrodes TE1 to TE11 of the touch sensing unit TSU are driven in the self-capacitance method is 399.36 (see FIG. 9), and the self-capacitance of the counter electrode CTE is 800, the size of CSe may be calculated so that a value of “(800/486)*26*CSe” is equal to 399.36 described above. Accordingly, CSe may be about 9.31. Finally, when the first touch electrodes TE1 to TE11 are driven in the self-capacitance method, the touch driving circuit 400 may generate a counter driving signal CDS having the size of 9.31 V and a phase that is inverted by 180 degrees with respect to the above-described touch driving signal TDS (e.g., the touch driving signal TDS applied to the first_first touch electrode TE1 in the self-capacitance method), and apply the generated counter driving signal CDS to the counter electrode CTE. Then, the electromagnetic waves generated from the touch sensing unit TSU when the first touch electrodes TE1 to TE11 of the touch sensing unit TSU are driven in the self-capacitance method may be attenuated by counter electromagnetic waves generated from the electromagnetic wave attenuation unit EAU based on the counter driving signal CDS of 9.31 V described above.

As another example, when the actual capacitance (e.g., Cs2) of all the second touch electrodes RE1 to RE16 is 26 pF (see FIG. 9), the maximum self-capacitance having the largest value among the self-capacitances of the second touch electrodes RE1 to RE16 is 486 (see FIG. 8), the EMI emission factor of the touch sensing unit TSU when the second touch electrodes RE1 to RE16 of the touch sensing unit TSU are driven in the self-capacitance method is 230.88 (see FIG. 9), and the self-capacitance of the counter electrode CTE is 800, the size of CSe may be calculated so that a value of “(800/486)*26*CSe” is equal to 230.88 described above. Accordingly, CSe may be about 5.38. Finally, when the second touch electrodes RE1 to RE16 are driven in the self-capacitance method, the touch driving circuit 400 may generate a counter driving signal CDS having the size of 5.38 V and a phase that is inverted by 180 degrees with respect to the above-described touch driving signal TDS (e.g., the touch driving signal TDS applied to the second_first touch electrode RE1 in the self-capacitance method), and apply the generated counter driving signal CDS to the counter electrode CTE. Then, the electromagnetic waves generated from the touch sensing unit TSU when the second touch electrodes RE of the touch sensing unit TSU are driven in the self-capacitance method may be attenuated by counter electromagnetic waves generated from the electromagnetic wave attenuation unit EAU based on the counter driving signal CDS of 5.38 V described above.

As still another example, when the EMI emission factor of the touch sensing unit TSU when the first_first touch electrode TE1 of the touch sensing unit TSU is driven in the mutual capacitance method is 46.72 (see FIG. 11) and the self-capacitance of the counter electrode CTE is 800, the size of CSe may be calculated so that a value of “(800/486)*26*CSe” is equal to 46.72 described above. Accordingly, CSe may be about 1.09. Finally, when the first_first touch electrode TE1 is driven in the mutual capacitance method, the touch driving circuit 400 may generate a counter driving signal CDS having the size of 1.09 V and a phase that is inverted by 180 degrees with respect to the above-described touch driving signal TDS (e.g., the touch driving signal TDS applied to the first_first touch electrode TE1 in the mutual capacitance method), and apply the generated counter driving signal CDS to the counter electrode CTE. Then, the electromagnetic waves generated from the touch sensing unit TSU when the first_first touch electrode TE1 of the touch sensing unit TSU is driven in the mutual capacitance method may be attenuated by counter electromagnetic waves generated from the electromagnetic wave attenuation unit EAU based on the counter driving signal CDS of 1.09 V described above.

As still another example, when the EMI emission factor of the touch sensing unit TSU when the first_second touch electrode TE2 the touch sensing unit TSU is driven in the mutual capacitance method is 46.24 (see FIG. 11) and the self-capacitance of the counter electrode CTE is 800, the size of CSe may be calculated so that a value of “(800/486)*26*CSe” is equal to 46.24 described above. Accordingly, CSe may be about 1.08. Finally, when the first_second touch electrode TE2 is driven in the mutual capacitance method, the touch driving circuit 400 may generate a counter driving signal CDS having the size of 1.08V and a phase that is inverted by 180 degrees with respect to the above-described touch driving signal TDS (e.g., the touch driving signal TDS applied to the first_second touch electrode TE2 in the mutual capacitance method), and apply the generated counter driving signal CDS to the counter electrode CTE. Then, the electromagnetic waves generated from the touch sensing unit TSU when the first_second touch electrode TE2 of the touch sensing unit TSU is driven in the mutual capacitance method may be attenuated by counter electromagnetic waves generated from the electromagnetic wave attenuation unit EAU based on the counter driving signal CDS of 1.08V described above.

The display device 10 according to the embodiment may be applied to various electronic devices. An electronic device according to an embodiment may include the display device 10 described above, and may further include a module or device having additional functions in addition to the display device 10.

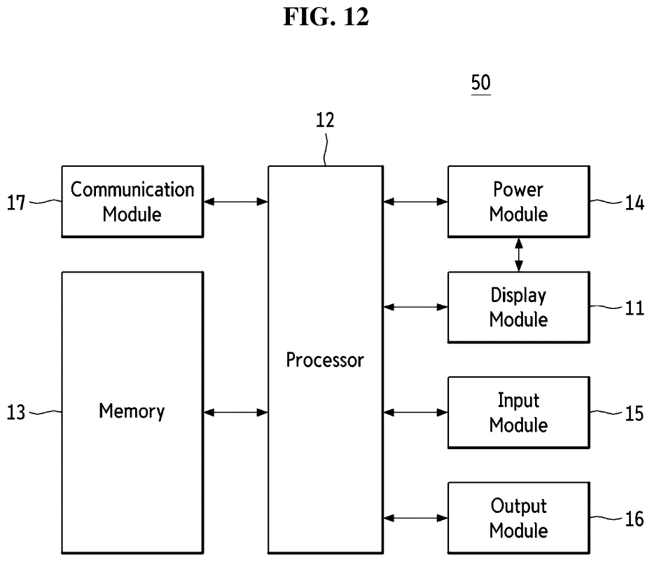

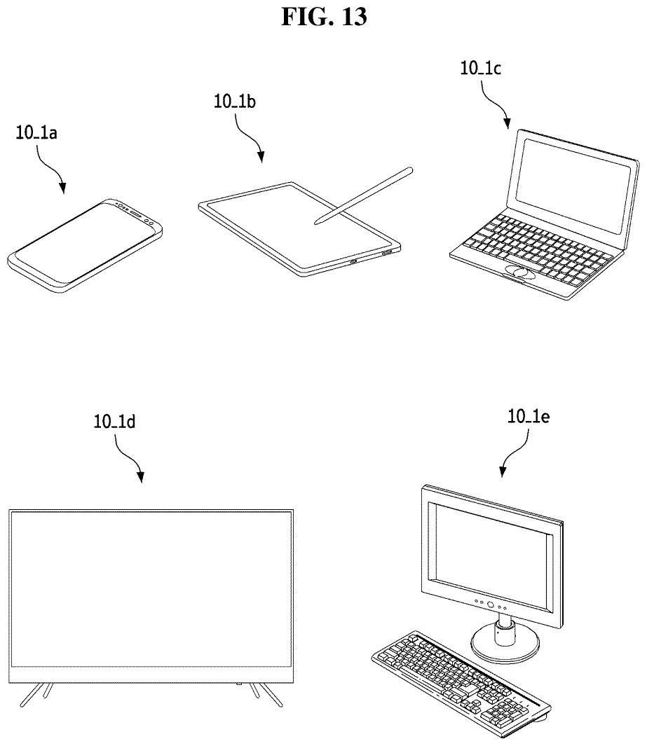

FIG. 12 is a block diagram of an electronic device according to an embodiment. Referring to FIG. 12, an electronic device 50 according to an embodiment may include a display module 11, a processor 12, a memory 13, and a power module 14. The electronic device 50 may further include an input module 15, a non-image output module 16, or a communication module 17.

The electronic device 50 may output various information in the form of an image through the display module 11. When the processor 12 executes an application stored in the memory 13, image information provided by the application may be provided to the user through the display module 11. The power module 14 may include a power supply module, such as a power adapter or a battery device, and a power conversion module that converts power supplied by the power supply module to generate power required for an operation of the electronic device 50. The input module 15 may provide input information to the processor 12 or the display module 11. The non-image output module 16 may serve to receive information other than the image received from the processor 12, such as sound, haptics, and light emission, and provide the information to the user. The communication module 17 is a module responsible for transmitting and receiving information between the electronic device 50 and an external device, and may include a receiving unit and a transmitting unit.

At least one of the components of the electronic device 50 described above may be included in the display device according to the above-described embodiments. In addition, some of the individual modules functionally included within one module may be included within the display device, while others may be provided separately from the display device. For example, the display device 10 includes the display module 11, and the processor 12, the memory 13, and the power module 14 may be provided in the form of other devices within the electronic device 50 other than the display device 10.

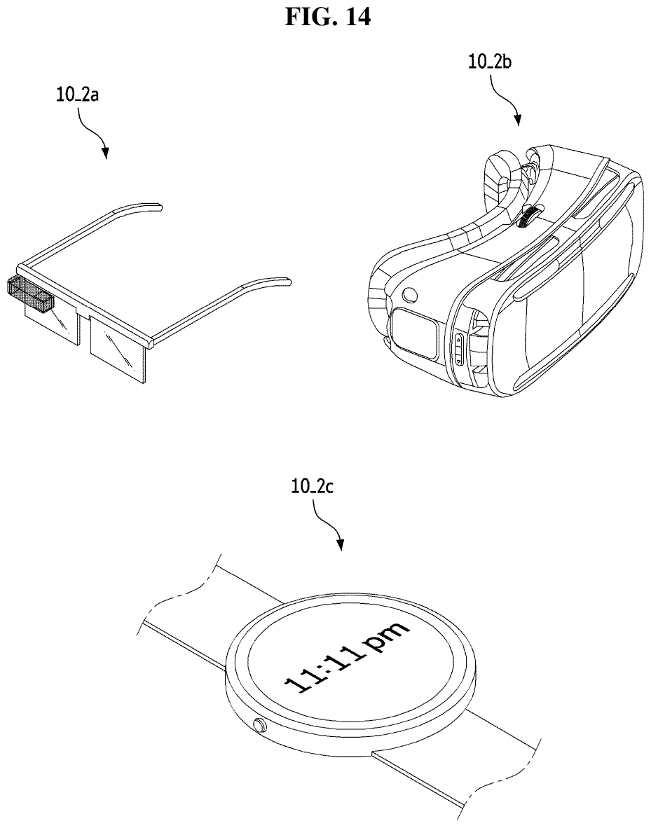

FIGS. 13, 14, and 15 are schematic diagrams of electronic devices according to various embodiments. FIGS. 13 to 15 illustrate examples of various electronic devices to which the display device 10 according to the embodiments is applied.

FIG. 13 illustrates examples of the electronic devices, including a smartphone 10_1a, a tablet PC 10_1b, a laptop 10_1c, a TV 10_1d, and a desk monitor 10_1e.

The smartphone 10_1a may include an input module such as a touch sensor and a communication module in addition to the display module 11. The smartphone 10_1a may process information received through the communication module or other input modules and display the information through the display module of the display device.

The tablet PC 10_1b, the laptop 10_1c, the TV 10_1d, and the desk monitor 10_1e also include a display module and an input module similarly to the smartphone 10_1a, and in some cases, may further include a communication module.

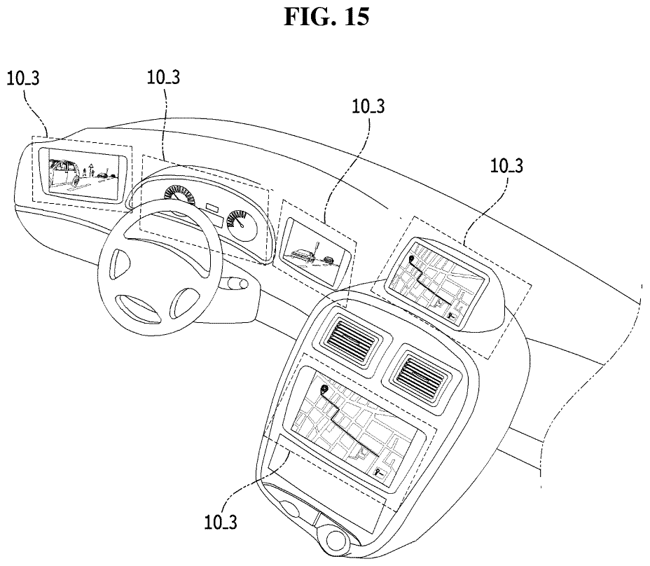

FIG. 14 illustrates an example in which an electronic device including a display module is applied to a wearable electronic device. The wearable electronic device may be a smart glasses 10_2a, a head mounted display 10_2b, a smart watch 10_2c, etc.

The smart glasses 10_2a and the head mounted display 10_2b may include a display module that emits a display image and a reflector that reflects the emitted display image and provides the reflected display image to the user's eyes, and may provide the user with a virtual reality or augmented reality screen through the display module and the reflector.

The smart watch 10_2c includes a biometric sensor as an input device and may provide the biometric information recognized by the biometric sensor to the user through the display module.

FIG. 15 illustrates a case where the electronic device 50 including the display module 11 is applied to a vehicle. For example, an electronic device 10_3 may be applied to a dashboard, center fascia, etc. of an automobile, or may be applied to a Center Information Display (CID) disposed on the dashboard of the automobile or a room mirror display replacing a side mirror.

In concluding the detailed description, those skilled in the art will appreciate that many variations and modifications can be made to the embodiments without substantially departing from the principles of the present invention. Therefore, the disclosed embodiments of the invention are used in a generic and descriptive sense and not for purposes of limitation.

What is claimed is:

1. A display device comprising:
a display panel;
a touch sensing unit disposed on a display area of the display panel;
an electromagnetic wave attenuation unit disposed on a non-display area of the display panel adjacent to the touch sensing unit; and
a touch driving circuit connected to the touch sensing unit and the electromagnetic wave attenuation unit,
wherein the touch sensing unit includes a plurality of first touch electrodes and a plurality of second touch electrodes disposed to intersect the plurality of first touch electrodes,
the electromagnetic wave attenuation unit includes a counter electrode,
the touch driving circuit supplies a touch driving signal to at least one type of touch electrode among the plurality of first touch electrodes and the plurality of second touch electrodes,
the touch driving circuit supplies a counter driving signal to the counter electrode, and
the touch driving circuit calculates a size of the counter driving signal based on an electromagnetic interference (EMI) emission factor detected from the touch sensing unit when the at least one type of touch electrode among the first touch electrodes and the second touch electrodes are driven by the touch driving signal.

2. The display device of claim 1, wherein the counter driving signal has a phase that is inverted by 180 degrees with respect to the touch driving signal.

3. The display device of claim 1, wherein the touch driving circuit calculates the size of the counter driving signal and adjusts an EMI emission factor of the electromagnetic wave attenuation unit so that the EMI emission factor of the touch sensing unit and the EMI emission factor of the electromagnetic wave attenuation unit become equal to each other.

4. The display device of claim 3, wherein when the touch driving circuit drives the first touch electrodes of the touch sensing unit in a self-capacitance method,
the EMI emission factor of the touch sensing unit is calculated by Mathematical Formula 1:
$$EFs 1 = SUMs 1 * Cs 1 * TDSs 1 ,$$
and
in the mathematical formula 1, EFs1 is the EMI emission factor of the touch sensing unit when the plurality of first touch electrodes of the touch sensing unit are driven in the self-capacitance method, SUMs1 is a sum of normalized self-capacitances of the plurality of first touch electrodes, Cs1 is an actual capacitance of the plurality of first touch electrodes, and TDSs1 is a size of a touch driving signal applied to the plurality of first touch electrodes.

5. The display device of claim 4, wherein the EMI emission factor of the electromagnetic wave attenuation unit is calculated by Mathematical Formula 2:
$$EFe = SFe * Ce * CSe ,$$
and
in the mathematical formula 2, EFe is the EMI emission factor of the electromagnetic wave attenuation unit, SFe is a normalized self-capacitance of the counter electrode, Ce is a real capacitance of the counter electrode, and CSe is a size of the counter driving signal.

6. The display device of claim 5, wherein an actual capacitance of the counter electrode is a same capacitance as the actual capacitance of the plurality of first touch electrodes.

7. The display device of claim 3, wherein when the touch driving circuit drives the second touch electrodes of the touch sensing unit in a self-capacitance method,
the EMI emission factor of the touch sensing unit is calculated by Mathematical Formula 3:
$$EFs 2 = SUMs 2 * Cs 2 * TDSs 2 ,$$
and
in the mathematical formula 3, EFs2 is the EMI emission factor of the touch sensing unit when the plurality of second touch electrodes of the touch sensing unit are driven in the self-capacitance method, SUMs2 is a sum of normalized self-capacitances of the plurality of second touch electrodes, Cs2 is an actual capacitance of the plurality of second touch electrodes, and TDSs2 is a size of the touch driving signal applied to the plurality of second touch electrodes.

8. The display device of claim 3, wherein when the touch driving circuit drives the first touch electrodes of the touch sensing unit in a mutual capacitance method,
the EMI emission factor of the touch sensing unit is calculated by Mathematical Formula 4:
$$EFm = SUMm * Cm * TDSm ,$$
and
in the mathematical formula 4, EFsm is the EMI emission factor of the touch sensing unit when a plurality of first touch electrodes of the touch sensing unit are driven in the mutual capacitance method, SUMsm is a sum of normalized self-capacitances of the plurality of first touch electrodes, Csm is an actual capacitance between the plurality of first touch electrodes and the plurality of second touch electrodes, and TDSsm is a size of the touch driving signal applied to the plurality of first touch electrodes.

9. The display device of claim 1, further comprising a counter driving signal line connecting the counter electrode and the touch driving circuit to each other.

10. The display device of claim 9, further comprising a counter pad connecting the counter driving signal line and the touch driving circuit.

11. The display device of claim 1, wherein the counter electrode includes a plurality of counter electrodes connected to each other by a connection line.

12. The display device of claim 1, wherein the counter driving signal and the touch driving signal are synchronized.

13. The display device of claim 1, wherein the counter electrode includes the same material as the plurality of first touch electrodes.

14. The display device of claim 1, wherein when the touch sensing unit is driven by a self-capacitance method, the touch driving signal is simultaneously applied to the first touch electrodes, and
after the first touch electrodes are driven, the touch driving signal is simultaneously applied to the second touch electrodes.

15. The display device of claim 1, wherein when the touch sensing unit is driven in a mutual capacitance method, the touch driving signal is sequentially applied to the first touch electrodes.

16. An electronic device comprising:
a display device providing a display screen,
wherein the display device includes:
a display panel;
a touch sensing unit disposed on a display area of the display panel;
an electromagnetic wave attenuation unit disposed on a non-display area of the display panel adjacent to the touch sensing unit; and
a touch driving circuit connected to the touch sensing unit and the electromagnetic wave attenuation unit,
the touch sensing unit includes a plurality of first touch electrodes and a plurality of second touch electrodes disposed to intersect the plurality of first touch electrodes,
the electromagnetic wave attenuation unit includes a counter electrode,
the touch driving circuit supplies a touch driving signal to at least one type of touch electrode among the plurality of first touch electrodes and the plurality of second touch electrodes,
the touch driving circuit supplies a counter driving signal to the counter electrode, and
the touch driving circuit calculates a size of the counter driving signal based on an electromagnetic interference (EMI) emission factor detected from the touch sensing unit when the at least one type of touch electrode among the first touch electrodes and the second touch electrodes are driven by the touch driving signal.

17. The electronic device of claim 16, wherein the counter driving signal has a phase that is inverted by 180 degrees with respect to the touch driving signal.

18. The electronic device of claim 16, wherein the touch driving circuit calculates the size of the counter driving signal and adjusts an EMI emission factor of the electromagnetic wave attenuation unit so that the EMI emission factor of the touch sensing unit and an EMI emission factor of the electromagnetic wave attenuation unit become equal to each other.

19. The electronic device of claim 18, wherein when the touch driving circuit drives the first touch electrodes of the touch sensing unit in a self-capacitance method,
the EMI emission factor of the touch sensing unit is calculated by Mathematical Formula 1:
$$EFs 1 = SUMs 1 * Cs 1 * TDSs 1 ,$$
and
in the mathematical formula 1, EFs1 is the EMI emission factor of the touch sensing unit when the plurality of first touch electrodes of the touch sensing unit are driven in the self-capacitance method, SUMs1 is a sum of normalized self-capacitances of the plurality of first touch electrodes, Cs1 is an actual capacitance of the plurality of first touch electrodes, and TDSs1 is a size of a touch driving signal applied to the plurality of first touch electrodes.

20. The electronic device of claim 17, wherein the electronic device includes a smartphone, a tablet, a laptop, a TV, a desk monitor, a smart glasses, a smart watch, a head mounted display, and a vehicle.
